(19) United States
(12) Patent Application Publication
(10) Pub. No.: US 2004/0043115 A1
(43) Pub. Date: Mar. 4, 2004

(54) Cut potato piece with condiment trough

(76) Inventor: George A. Mendenhall, Boise, ID (US)

Correspondence Address: FRANK J. DYKAS, DYKAS, SHAVER & NIPPER, LLP, P.O. BOX 877, BOISE, ID, 83701-0877, US

(21) Appl. No.: 10/378,121

(22) Filed: Feb. 28, 2003

Related U.S. Application Data
(63) Continuation-in-part of application No. 10/231,924, filed on Aug. 29, 2002.

(51) Int. Cl. A21D 13/00

(52) U.S. Cl. 426/138

(57) ABSTRACT

A condiment holding cut piece of potato suitable for use as a french fry is provided. The cut piece is cut using a hydraulic cutter with a cross-sectional configuration which forms a trough suitable for holding condiments. The cross-sectional configurations include scoop, channel, and X or V shaped configurations.

### PRIORITY

This is a continuation-in-part of U.S. patent application Ser. No. 10/231,924 originally filed on Aug. 29, 2002.

### DESCRIPTION

### BACKGROUND OF THE INVENTION

Field of the Invention. The present invention generally relates to cut potato pieces formed in various shapes such as a scoop, channel, and/or V or X shaped so as to define a trough integral within said cut potato piece for holding a condiment.

Background Information. Cut potato pieces that are deep fried are commonly known in the United States as french fries and elsewhere in the world by a variety of names, most commonly as chips. Enormous amounts of potatoes are so consumed by the public as french fries or chips, with a considerable percentage thereof being prepared and served to the public through the institutional food industries, such as restaurants, cafeterias, and the like.

The vast majority of the french fries are consumed in conjunction with condiments, such as ketchup, french fry sauces, and salt.

Given the size and competitiveness of the industry, there is considerable interest in new french fry products. New and interesting shapes of french fries are always of interest in the market as they attract the purchasing public. Examples of some of these new and interesting shapes of cut french fry pieces include the helical spiral cut, commonly known as a curly fry, wedge cuts, rectangular cuts, commonly known as steak fries, and a variety of potato cut pieces in the shape of letters of the alphabet.

There are three ways to cut french fries. The first is simply using a knife, and while this may suffice at home, it is not a feasible method of cutting french fries on a commercial scale. The most common and by far the most efficient commercial means of cutting french fries is through the use of a hydraulic cutter. An example of a hydraulic cutter is shown in U.S. Pat. No. 5,046,388 issued Sep. 10, 1991. Hydraulic cutters have proven to be highly reliable devices with very large cutting capacities that can range from 20,000 to 40,000 pounds per hour. These machines are not labor intensive and as a result are very efficient and, given the competitive nature of the industry, the cutting means of choice.

Another way of cutting french fry pieces is through the use of a mechanical cutter. The mechanical cutters are complex mechanical machines and have far lower production rates. The production is typically 4,000 to 7,000 pounds per hour. These machines are labor intensive, since they must be constantly monitored and maintained. One hydraulic cutting assembly operated by one or two maintenance people can easily outperform several mechanical cutters maintained by far more skilled maintenance people and operators. As a result, mechanical cutters have fallen into disfavor, particularly in the more efficient processing plants.

There is a limitation inherent to the hydraulic cutter, namely that it only cuts in one direction and is not capable of being used to crosscut much of anything. As a general rule, decorative or novel shaped french fry pieces cannot be cut by a hydraulic cutter. As a result, a hybrid system of producing decorative cut potato pieces first uses a hydraulic cutter to form an elongated plug of a desired shape from the whole potato, which is then crosscut in a mechanical cutter. Examples of this technology can be seen in U.S. Pat. Nos. 4,372,184, 4,911,045, and 5,046,388. These production processes will produce decorative or novelty cuts of french fry pieces but is generally not favored by the industry because of the increased cost of production. Thus, the vast majority of french fries are cut in the standard square cross-sectional configuration.

In the typical potato processing plant, potatoes are cut into the desired shape of french fry pieces, sorted, inspected for quality control purposes, blanched, par fried, quick frozen, and then packaged. At the retail level, or even at home, the frozen cut potato pieces are removed from the package and usually deep fried, removed from the fryer and allowed to drain, seasoned to taste, and promptly served. When these potato pieces are still hot and crispy, they can be eaten as finger food wherein the consumer picks them up one or two at a time, dips them into a desired condiment, and consumes them. In some circles, this is called the “dip and lift” cycle. When placed on a plate, french fry pieces will actually continue to dry on the surface and become structurally a bit stronger. However, since the inner pulp material is not cooked to the same extent, it still contains a relatively large quantity of moisture which will eventually seep through to the surface and soften the piece. Therefore, the larger the french fry, the more likely that it will eventually become limp and softer as it cools off. This is one reason why smaller fry pieces are preferred by fast food marketers, namely that the fry pieces are quicker to cook and stay crisp longer after cooking.

As french fry pieces cool and get soggy and softer, the consumer must resort to the use of a utensil, most commonly the everyday fork. Even then, as square and rectangular shaped french fries cool, they become much weaker and will often break into smaller pieces, especially when being dipped into the desired condiments such as ketchup or a specially prepared french fry sauce.

There are other considerations in the retail industry which affect the size and shape of the french fry pieces. Some of the major factors are portions sizing, plate coverage, and plate presentation.

Portion sizing for some types of cut potato pieces is very difficult. This is particularly true for the helical spiral cut potato pieces that often interlock and can sometimes be inconsistent with very long pieces intermixed with much smaller broken pieces. As a result, it becomes very difficult to properly potion size and in turn effects plate presentation to the consumer.

Plate coverage is also important. This is more of a perception issue. A few very large french fries may contain the same amount of potato as a larger number of smaller french fries, but it is likely to be perceived as a smaller portion by the consumer.

As a result, the vast majority of french fries served in the United States and throughout the world are the typical, routine shaped french pieces with a generally square shaped cross-sectional configuration. This is done because of the ease of cooking, portion sizing, and maintaining good plate presentation. When these potato pieces are still hot and crisp, they can be eaten as finger food wherein the consumer picks them up one or two at a time, dips them into a desired condiment, and lifts them up to consume them. As they cool and get soggy and softer, the consumer may resort to the use of a utensil, most commonly the everyday fork. Even then, as the rectangular shaped french fries cool, they become much weaker and will often break into smaller pieces, especially when being dipped into the desired condiments such as ketchup or a specially prepared french fry sauce.

One thing that is almost universally common with respect to the sauces used as condiments that are served with french fries is that they are all relatively thin fluids. The reason is simple. The french fry piece does not have a lot of shear strength and will easily break if one were to attempt to dip it into a thicker condiment such as peanut butter.

There is absolutely no reason that other condiments would not appeal to consumer's pallets. These would include condiments that could be dipped, or even would be filled into a cavity or trough. This could turn the common french fry into gourmet hors d'oeuvres. For example, creme cheese and a coating of caviar could be used as condiments with a cooked french fry piece. However, the problem with that is that the creme cheese is too viscous and the conventional french fry piece too weak to allow the traditional dip and lift method of coating and consuming a condiment with a french fry piece. One could take a utensil and spread creme cheese on a cooked french fry piece, but it would be time consuming and probably messy to do this.

What is needed is a cut french fry piece that contains a trough for holding condiments. What is also needed is a cut french fry piece that, when cooked, is stronger and less resistant to bending and breaking when utilized to dip and/or lift a condiment.

Accordingly, it is an object of the present invention to provide a cut potato piece suitable for preparation as a french fry which is stronger, less resistant to bending and breaking, and provides a trough suitable to dipping into or being filled with condiments. It is another object of the present invention to provide a design for a cut potato piece that generates consumer interest. Another object is to provide a design for a cut potato piece that can be easily produced using a hydraulic cutter and without the need for cross-cutting.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

A first embodiment of a scoop shaped potato piece formed of cut potato piece having a lower convex surface and an upper concave surface forming a condiment trough. The end surfaces are generally vertical. However, if the cut potato piece is cut from a whole potato, the vertical end surfaces may just as likely be angular in shape as they would conform to a portion of the forward or rearward ends of the potato as it was being cut. The side surfaces are also generally vertical and flat. This is a preferred embodiment and is cut by the cutter in my U.S. patent application Ser. No. 10/231,924 originally filed Aug. 29, 2002, the teachings of which are wholly incorporated herein by reference.

A second embodiment of a scoop shaped potato piece is that of an ‘X’ shaped potato piece, which is formed of a cut potato piece, a pair of base legs, and upper legs, which form a trough therein. This embodiment has the advantage of having a pair of base legs that enables the ‘X’ shaped potato piece to be placed securely on a flat surface such as a serving tray.

A third embodiment of a scoop shaped potato piece is a channel potato piece formed of a cut potato piece having a base portion and a pair of sides thereby forming a trough.

A fourth embodiment of a scoop shaped potato piece is that of a ‘V’ shaped potato piece formed of cut potato piece having a pair of angular sides defining a condiment trough.

All of these pieces can be formed from various configurations of cutter blades as shown and fully described in the aforementioned patent application. The various configurations of cutter blades should be readily apparent to those skilled in the art using cutter blade assemblies in hydro-gun cutting devices for cutting pieces of potato.

Further, the purpose of the foregoing abstract is to enable the United States Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measure by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective representational view of a cut potato piece having a scoop shaped condiment trough.

FIG. 2 is a top plan view of the cut potato piece having a scoop shaped condiment trough.

FIG. 3 is a side view of the cut potato piece having a scoop shaped condiment trough.

FIG. 4 is a bottom plan view of the cut potato piece having a scoop shaped condiment trough.

FIG. 5 is an end view of the cut potato piece having a scoop shaped condiment trough.

FIG. 6 is a perspective representational view of a cut potato piece formed in an ‘X’ shaped configuration and having a condiment trough.

FIG. 7 is a perspective representational view of a cut potato piece formed in a channel shaped configuration and having a condiment trough.

FIG. 8 is a perspective representational view of a cut potato piece formed in a ‘V’ shaped configuration and having a condiment trough.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

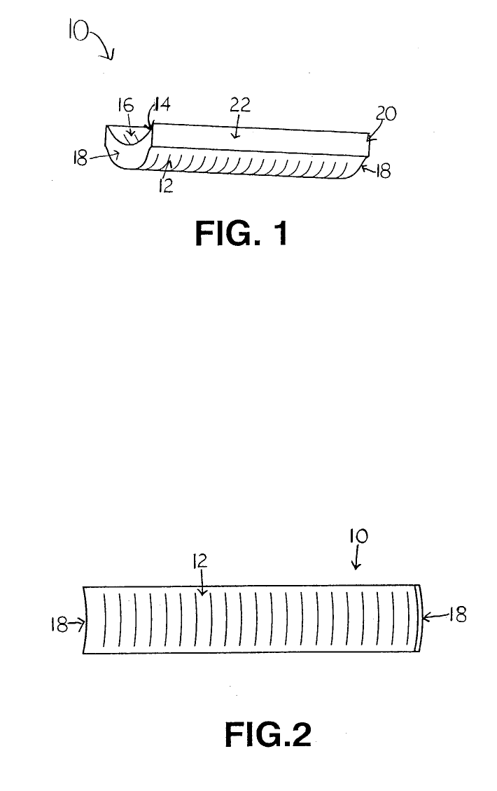

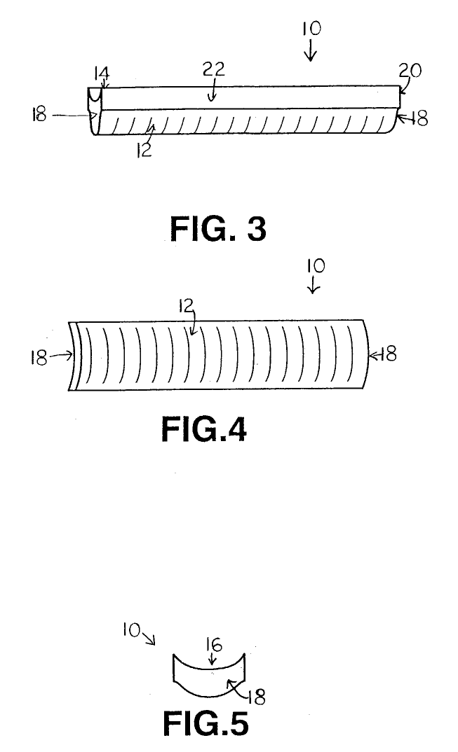

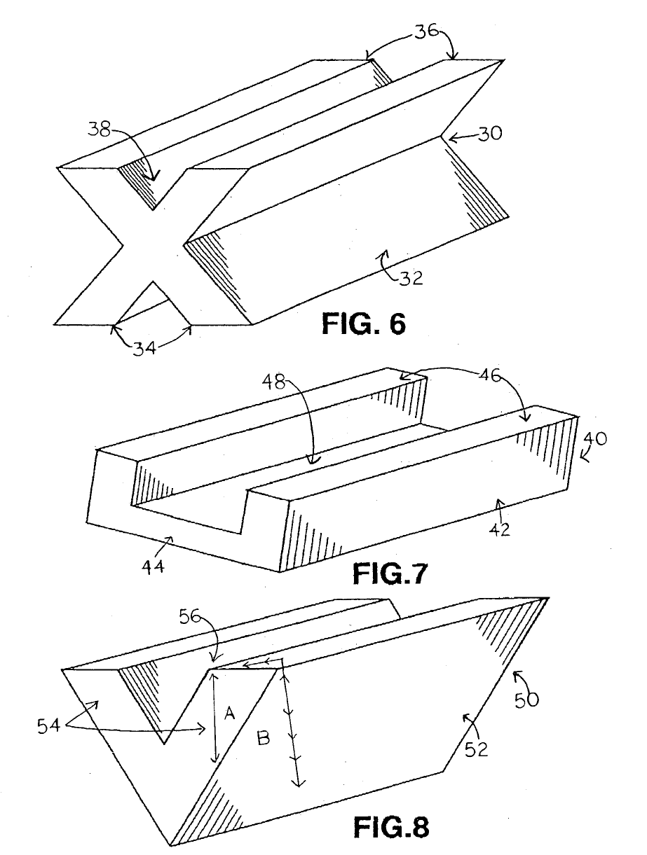

Referring now to FIGS. 1-5, there is shown a first embodiment of a scoop shaped potato piece 10. It is formed of cut potato piece 22 having lower convex surface 12 and upper concave surface 14 forming a condiment trough 16. As shown in the drawings, end surfaces 18 are generally vertical. However, if the cut potato piece 22 is cut off of a whole potato, vertical end surfaces 18 may just as likely be angular in shape as they would conform to a portion of the forward or rearward ends of the potato as it was being cut. Side surfaces 20 are also shown as generally vertical and flat. This is a preferred embodiment and is cut by the cutter in my U.S. patent application Ser. No. 10/231,924 originally filed Aug. 29, 2002, the teachings of which are wholly incorporated herein by reference.

There is shown in FIG. 6 a perspective, representational view of an ‘X’ shaped potato piece embodiment 30, which is formed of cut potato piece 32, a pair of base legs 34, and upper legs 36 forming trough 38. This embodiment has the advantage of having a pair of base legs that enable the ‘X’ shaped potato piece to be placed securely on a flat surface such as a serving tray.

In FIG. 7, there is shown a channel potato piece 40 formed of a cut potato piece 42 having base portion 44 and a pair of sides 46 thereby forming a trough 48.

In FIG. 8, there is shown a perspective, representational view of ‘V’ shaped potato piece 50 formed of cut potato piece 52 having a pair of angular sides 54 defining a condiment trough 56.

All of these pieces can be formed from various configurations of cutter blades as shown and fully described in the aforementioned patent application. The various configurations of cutter blades should be readily apparent to those skilled in the art using cutter blade assemblies in hydro-gun cutting devices for cutting pieces of potato.

These configurations for cut potato pieces are considerably more resistant to bending and/or breakage when used to scoop condiments or are filled with condiments. Tests were conducted regarding the first embodiment, namely the scoop shaped potato piece 10 wherein scoop shaped potato piece 10 was compared to a more standard cut potato piece cut in the shape of a steak fry having a rectangular cross-sectional area and having an identical cross-sectional area. All test pieces were cut from the same Russet Burbank potato. In the tests, test samples were each four and one-half inches long and formed of a potato piece being 0.300 inches thick and three-quarters of an inch wide. The scoop shaped potato piece 10 used in the test sample were, of course, semi-circular in shape, with the steak fry being of the same rectangular thickness and width, except flat. The cross-sectional area of each of the samples was 0.19 square inches, thus each of the samples had the same amount of potato piece mass and the same cross-sectional area. After the test samples were cut to length and size, they were simultaneously deep fried in the same vegetable oil at 350 degrees Fahrenheit for two minutes. Then, each of the samples was placed on a channel shaped bridge, which supported the end portions of each of the test sample cut potato pieces at a span of three and three quarter inches apart.

A string was then wrapped around the center point of the bridged portion of each of the cut potato pieces. The string hung down through a slot in the base portion of the bridge where each was weighted with fifteen grams of weight. The deflection or sag of the test sample cut potato pieces between the two supports of the test bridge was then measured in millimeters every thirty seconds from the underside at the middle of the sample to the base of the bridge. The samples were said to have failed if they broke in two or sagged down to the base of the bridge, which was approximately twenty-eight millimeters below the bottoms of the test pieces.

The test sample configured as a flat, rectangular cross-sectional steak fry immediately began to bend, and continued bending at a generally steady, linear rate, and broke into two pieces within approximately 115 seconds. The second sample was the scoop shape potato piece shown in FIGS. 1 through 5 and was bridged in a concave side down configuration, which would be upside down relative to the condiment trough. This test sample did not break, however it did bend to the maximum allowable twenty-eight millimeters in approximately 350 seconds.

The next test sample of the scoop shaped potato pieces was reoriented to present the concave side up, which would be the normal configuration in which the piece would be used to scoop and hold a condiment. The scoop shaped potato piece neither broke nor deflected to the maximum allowable during the first 350 seconds of testing.

The test results revealed that the scoop shaped potato piece is at least twice as resistant to bending and breaking as a rectangular configured, flat steak fry.

While the exact factors that generate this increase in resistance to bending and breakage are not definitively known, it is the inventor's opinion that the increased vertical component of the fried surface area as shown by referenced dimension A and the increased vertical component of the potato core shown by referenced dimension B are contributing factors to the apparent increase in resistance to bending or breaking as shown in FIG. 8.

It should be readily apparent to anyone skilled in the art that once these cut potato pieces are fried and ready for consumption, they are also readily amendable to being packed with condiments or used as scoop to dip and lift condiments for the consumers.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A condiment holding potato piece comprising a cut piece of potato having a condiment holding tough.

2. A scoop shaped potato piece which comprises a cut piece of potato having a convex lower surface, a concave upper surface, and generally flat side surfaces, wherein said concave upper surface is configured to hold a condiment.

3. A scoop shaped potato piece which comprises a cut piece of potato configured in a cross-sectional shape of a V for holding a condiment within the interior trough defined by said V configuration.

4. A scoop shaped potato piece which comprises a cut piece of potato configured in a cross-sectional shape of an X for holding a condiment within at least one of the troughs defined by said X configuration.

5. A scoop shaped potato piece which comprises a cut piece of potato configured in a cross-sectional shape of a channel for holding a condiment within the interior trough defined by said channel configuration.
